(19) United States
(12) Patent Application Publication
(10) Pub. No.: US 2004/0213124 A1
(43) Pub. Date: Oct. 28, 2004

(54) Optical recording medium and data recording apparatus for recording data in the same

(75) Inventors: Hiroshi Shingai, Tokyo (JP); Tatsuya Kato, Tokyo (JP); Hideki Hirata, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/825,895

(22) Filed: Apr. 16, 2004

(30) Foreign Application Priority Data
Apr. 28, 2003 (JP) 2003-123073

(51) Int. Cl. G11B 7/24

(52) U.S. Cl. 369/94; 369/288; 369/47.53; 369/59.11

(57) ABSTRACT

An optical recording medium includes a recording layer, a first dielectric layer disposed on the side of a light incidence plane through which the laser beam enters with respect to the recording layer, a second dielectric layer disposed on the side opposite to the light incidence plane with respect to the recording layer, a heat radiation layer disposed on the side of the light incidence plane with respect to the first dielectric layer and a reflective layer disposed on the side opposite to the light incidence plane with respect to the second dielectric layer, the recording layer containing a phase change material represented by an atomic composition formula: SbₐTe_{b}Ge_{c}Tb_{d}, where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9, in an amount equal to or more than 95 atomic %.

According to the thus constituted optical recording medium, it is possible to simultaneously improve characteristics of recording data therein at a high linear velocity, data reproduction durability and storage reliability.

### BACKGROUND OF THE INVENTION

The present invention relates to an optical recording medium and, particularly, to a data rewritable type optical recording medium whose characteristics of recording data therein at a high linear velocity can be improved and whose data reproduction durability and storage reliability can be simultaneously improved. The present invention also relates to a data recording apparatus which can record data in an optical recording medium at a high linear velocity and directly overwrite data recorded in an optical recording medium at a high linear velocity.

### DESCRIPTION OF THE PRIOR ART

Optical recording media such as the CD, DVD and the like have been widely used as recording media for recording digital data. These optical recording media can be roughly classified into optical recording media such as the CD-ROM and the DVD-ROM that do not enable writing and rewriting of data (ROM type optical recording media), optical recording media such as the CD-R and DVD-R that enable writing but not rewriting of data (write-once type optical recording media), and optical recording media such as the CD-RW and DVD-RW that enable rewriting of data (data rewritable type optical recording media).

As well known in the art, data are generally recorded in a ROM type optical recording medium using prepits formed in a substrate in the manufacturing process thereof, while in a write-once type optical recording medium, an organic dye such as a cyanine dye, phthalocyanine dye or azo dye is generally used as the material of the recording layer and data are recorded utilizing changes in an optical characteristic caused by chemical change of the organic dye, which change may be accompanied by physical deformation.

On the other hand, in a data rewritable type optical recording medium, a phase change material is generally used as the material of the recording layer and data are recorded utilizing changes in an optical characteristic caused by phase change of the phase change material. More specifically, since the reflection coefficients of the phase change material are different between the case where the phase change material is in a crystal phase and the case where it is in an amorphous phase, data can be recorded and reproduced utilizing these characteristics of the phase change material.

In the case where data are to be recorded in a recording layer of a data rewritable type optical recording medium, a laser beam whose power is set to a recording power Pw having a sufficiently high level is projected onto the recording layer to heat a region of the recording layer irradiated with the laser beam to a temperature equal to or higher than the melting point of a phase change material, thereby melting the region of the recording layer. Then, a laser beam whose power is set to a bottom power Pb having a sufficiently low level is projected onto the recording layer to quickly cool the melted region of the recording layer. As a result, the phase of the phase change material contained in the region of the recording layer changes from a crystal phase to an amorphous phase to form a record mark, thereby recording data therein.

On the other hand, in the case where a record mark formed in the recording layer of a data rewritable type optical recording medium is to be erased, a laser beam whose power set to the erasing power Pe having a level lower than the recording power Pw and equal to or higher than the bottom power Pb is projected onto the recording layer to heat a region of the recording layer where a record mark is formed to a temperature equal to or higher than the crystallization temperature of the phase change material and the region of the recording layer heated to the temperature equal to or higher than the crystallization temperature of the phase change material is gradually cooled. Thus, the phase of the phase change material contained at the region of the recording layer where the record mark was formed changes from an amorphous phase to a crystalline phase and the record mark is erased.

Therefore, it is possible not only to form a record mark in the recording layer but also to directly overwrite a record mark formed in the region of the recording layer by modulating the power of the laser beam projected onto the recording layer between a plurality of levels corresponding to the recording power Pw, the bottom power Pb and the erasing power Pe.

A chalcogen system alloy such as a GeSbTe system alloy, an AgInSbTe alloy or the like is known as a phase change material usable for a recording layer of a data writable type optical recording medium.

A chalcogen system alloy containing Sb and Te has a high crystallization speed and is suitable as a phase change material for a recording layer of a data writable type optical recording medium in which data are recorded at a high speed. Of particular interest is that the crystallization speed of a chalcogen system alloy increases as the ratio of Sb to Te contained in the alloy increases. An optical recording medium whose recording layer contains such an alloy therefore enables recorded data to be directly overwritten at a high linear velocity.

However, as the ratio of Sb to Te contained in a chalcogen system alloy increases, the crystallization temperature of the chalcogen system alloy decreases while the crystallization speed of the chalcogen system alloy increases and, therefore, the thermal stability thereof in an amorphous phase becomes lower. Specifically, in the case where the crystallization temperature of a chalcogen system alloy contained in a recording layer of an optical recording medium is low, the storage reliability of the optical recording medium may be degraded because there is a risk of record marks being erased when data are repeatedly reproduced from the optical recording medium or the optical recording medium is stored in a high-temperature atmosphere.

### SUMMARY OF THE INVENTION

It is therefore an object of the present invention to provide a data rewritable type optical recording medium that has improved high-linear-velocity data recording characteristics and is simultaneously improved in data reproduction durability and storage reliability.

It is another object of the present invention to provide a data recording apparatus which can record data in an optical recording medium at a high linear velocity and directly overwrite data recorded in an optical recording medium at a high linear velocity.

The above and other objects of the present invention can be accomplished by an optical recording medium comprising a recording layer in which a record mark can be formed by projecting a laser beam thereonto, a first dielectric layer disposed on the side of the recording layer on which a light incidence plane through which the laser beam enters is present, a second dielectric layer disposed on the side of the recording layer opposite from that on which the light incidence plane is present, a heat radiation layer disposed on the side of the first dielectric layer on which the light incidence plane is present and a reflective layer disposed on the side of the second dielectric layer opposite from that on which the light incidence plane is present, the recording layer containing a phase change material represented by an atomic composition formula: SbₐTe_{b}Ge_{c}Tb_{d}, where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9, in an amount equal to or more than 95 atomic %.

In a study done by the inventors of the present invention, it was found that the phase change material represented by the above atomic composition formula: SbₐTe_{b}Ge_{c}Tb_{d} had an extremely high crystallization speed and, therefore, in the case where an optical recording medium included a recording layer containing the phase change material in an amount equal to or more than 95 atomic %, data recorded in the recording layer of the optical recording medium could be overwritten at an extremely high linear velocity, for example, a linear velocity equal to or higher than 14 m/sec and equal to or lower than 33 m/sec.

In a further study done by the inventors of the present invention, it was found that since the phase change material had a relatively high crystallization temperature and the thermal stability thereof in an amorphous phase was high, an optical recording medium that included a recording layer containing the phase change material in an amount equal to or more than 95 atomic % was improved in data reproduction durability and storage reliability.

To the contrary, in a study done by the inventors of the present invention, it was found that in the case where a was smaller than 63, c was larger than 10, d was smaller than 3, d was larger than 15, (a+d) was is smaller than 75, or a/b was smaller than 3.3, the crystallization temperature of the phase change material became too low and it was difficult to crystallize the phase change material to erase a record mark and that, on the other hand, in the case where a was larger than 78, (a+d) was is larger than 82, or a/b was larger than 4.9, since the crystallization temperature of the phase change material became too high, it was difficult to change the phase of the phase change material from the crystalline phase to the amorphous phase to form a record mark and the thermal stability of the phase change material was decreased. Further, the inventors of the present invention found that in the case where c was smaller than 2, since the content of Ge became too small, the crystallization speed became too low and the data reproduction durability and the storage reliability of the optical recording medium were lowered.

Therefore, according to the present invention, it is possible to directly overwrite data recorded in a recording layer of an optical recording medium and it is possible to simultaneously improve the data reproduction durability and the storage reliability of the optical recording medium.

In the present invention, in order to control the crystallization temperature of the phase change material, the recording layer may contain elements other than Sb, Te, Ge and Tb, such as Ag, In or the like, in an amount equal to or less than 5 atomic % and may further contain unavoidable impurities.

In a preferred aspect of the present invention, the heat radiation layer contains aluminum nitride as a primary component.

According to this preferred aspect of the present invention, since the heat radiation layer disposed on the side of the first dielectric layer on which the light incidence plane is present contains aluminum nitride as a primary component, the heat radiation characteristics of the recording layer can be increased and it is therefore possible to improve the durability of the optical recording medium when data are reproduced repeatedly.

Furthermore, according to this preferred aspect of the present invention, since the heat radiation layer is disposed on the side of the recording layer on which the light incidence plane is present, it is possible to prevent the heat radiation characteristics of the recording layer from increasing too much and it is therefore possible to effectively prevent the recording sensitivity of the optical recording medium from being lowered.

In the present invention it is preferable to form the heat radiation layer of a material containing 90 atomic % or more aluminum nitride and is more preferable to form it of a material containing 95 atomic % or more aluminum nitride.

In the present invention, it is preferable to form the heat radiation layer so as to have a thickness of 50 nm to 150 nm and is more preferable to form it so as to have a thickness of 80 nm to 120 nm.

In a preferred aspect of the present invention, the reflective layer contains Ag or alloy containing 90 atomic % or more of Ag.

According to this preferred aspect of the present invention, since the reflective layer disposed on the side of the second dielectric layer opposite from that on which the light incidence plane is present contains Ag or alloy containing 90 atomic % or more of Ag, the heat radiation characteristics of the recording layer can be increased and it is therefore possible to improve the durability of the optical recording medium when data are reproduced repeatedly.

In the present invention, each of the first dielectric layer and the second dielectric layer is preferably formed of a mixture of ZnS and SiO₂.

In the present invention, the first dielectric layer is preferably formed so as to have a thickness of 10 nm to 40 nm and the second dielectric layer is preferably formed so as to have a thickness of 3 nm to 14 nm.

In a preferred aspect of the present invention, there is written into the optical recording medium as data for setting recording conditions a pulse train pattern for modulating laser beam power between three levels including a recording power, an erasing power and a bottom power, wherein the number of pulses having a level equal to a recording power of the laser beam at the time of forming a record mark having a length of nT in the recording layer, where n is an integer equal to or larger than 2 and T is a length corresponding to one cycle of a reference clock, is determined to be n/2 when n is an even number and to be (n−1)/2 when n is an odd number.

According to this preferred aspect of the present invention, even in the case where data are to be recorded in the recording layer of the optical recording medium at an extremely high linear velocity, the time period during which the level of a laser beam is held equal to the recording power becomes long and, therefore, since the temperature of the recording layer can be accurately controlled, it is possible to form a record mark having a good shape in the recording layer of the optical recording medium.

In a preferred aspect of the present invention, a linear recording velocity equal to or higher than 14 m/sec and lower than 21 m/sec is written in the optical recording medium as data for setting recording conditions indicating a preferable linear recording velocity of data.

In a preferred embodiment of the present invention, data for setting recording conditions indicating that a ratio Pe/Pw of an erasing power of a laser beam Pe to a recording power Pw thereof should be determined to be equal to or larger than 0.26 and equal to or smaller than 0.70 are further written in the optical recording medium.

In a further preferred embodiment of the present invention, data for setting recording conditions indicating that a ratio Pe/Pw of an erasing power of a laser beam Pe to a recording power Pw thereof should be determined to be equal to or larger than 0.26 and equal to or smaller than 0.65 are written in the optical recording medium.

In another preferred aspect of the present invention, ID data for identifying the optical recording medium are written in the optical recording medium.

The above and other objects of the present invention can be also accomplished by a data recording apparatus comprising ID data reading means for reading ID data written in an optical recording medium for identifying the optical recording medium, a memory for storing data for setting recording conditions for each of ID data written in the optical recording media, and control means for setting recording conditions of data that, when the ID data indicates that the optical recording medium comprises a recording layer in which a record mark can be formed by projecting a laser beam thereonto, a first dielectric layer disposed on the side of the recording layer on which a light incidence plane through which the laser beam enters is present, a second dielectric layer disposed on the side of the recording layer opposite from that on which the light incidence plane is present, a heat radiation layer disposed on the side of the first dielectric layer on which the light incidence plane is present and a reflective layer disposed on the side of the second dielectric layer opposite from that on which the light incidence plane is present, and that the recording layer contains a phase change material represented by an atomic composition formula: SbₐTe_{b}Ge_{c}Tb_{d}, where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9, in an amount equal to or more than 95 atomic %, selects data for setting recording conditions stored in the memory in accordance with the values of a, c, d, (a+d) and a/b.

The above and other objects and features of the present invention will become apparent from the following description made with reference to the accompanying drawings.

### BRIEF DESCRIPTION OF THE DRAWINGS

FIG. 1 is a schematic perspective view showing an optical recording medium that is a preferred embodiment of the present invention.

FIG. 2 is an enlarged schematic cross-sectional view of the part of the optical recording medium indicated by A in FIG. 1.

FIG. 3 is a diagram showing the waveform of a pulse train pattern for modulating the power of a laser beam in the case of recording a 2T signal or a 3T signal in a recording layer of an optical recording medium shown in FIGS. 1 and 2.

FIG. 4 is a diagram showing the waveform of a pulse train pattern for modulating the power of a laser beam in the case of recording a 4T signal or a 5T signal in a recording layer of an optical recording medium shown in FIGS. 1 and 2.

FIG. 5 is a diagram showing the waveform of a pulse train pattern for modulating the power of a laser beam in the case of recording a 6T signal or a 7T signal in a recording layer of an optical recording medium shown in FIGS. 1 and 2.

FIG. 6 is a diagram showing the waveform of a pulse pattern for modulating the power of a laser beam in the case of recording an 8T signal in a recording layer of an optical recording medium shown in FIGS. 1 and 2.

FIG. 7 is a diagram showing a data recording apparatus for recording data in the optical recording medium 10.

### DESCRIPTION OF THE PREFERRED EMBODIMENTS

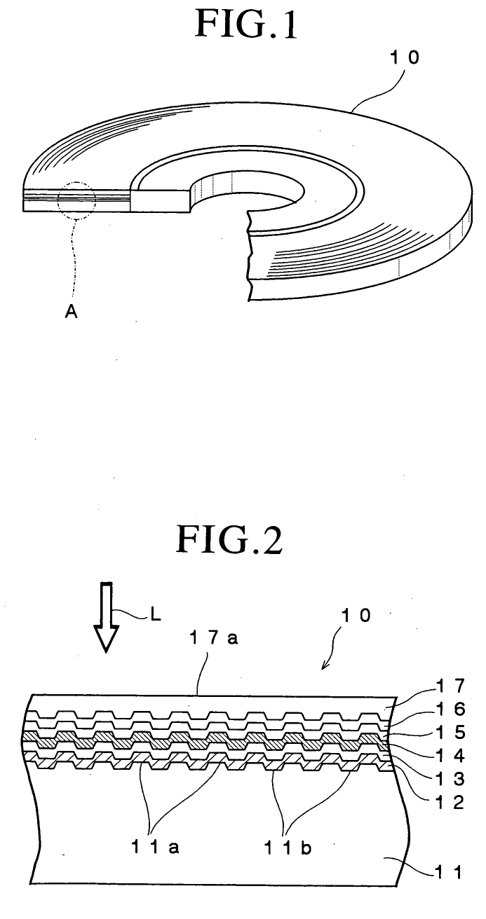

FIG. 1 is a schematic perspective view showing an optical recording medium that is a preferred embodiment of the present invention and FIG. 2 is a schematic enlarged cross-sectional view indicated by A in FIG. 1.

As shown in FIG. 1, an optical recording medium 10 according to this embodiment is formed disk-like and has an outer diameter of about 120 mm and a thickness of about 1.2 mm.

As shown in FIG. 2, the optical recording medium 10 according to this embodiment includes a disk-like support substrate 11, a reflective layer 12, a second dielectric layer 13, a recording layer 14, a first dielectric layer 15, a heat radiation layer 16 and a light transmission layer 17.

The optical recording medium 10 according to this embodiment is constituted so that a laser beam L having a wavelength λ of 380 nm to 450 nm is projected onto the recording layer 14 via the light transmission layer 17 and a light incidence plane 17a is formed by the surface of the light transmission layer 17.

The support substrate 11 serves as a support for ensuring mechanical strength and a thickness of about 1.2 mm required for the optical recording medium 10.

The material used to form the support substrate 11 is not particularly limited insofar as the support substrate 11 can serve as the support of the optical recording medium 10. The support substrate 11 can be formed of glass, ceramic, resin or the like. Among these, resin is preferably used for forming the support substrate 11 since resin can be easily shaped. Illustrative examples of resins suitable for forming the support substrate 11 include polycarbonate resin, polyolefin resin, acrylic resin, epoxy resin, polystyrene resin, polyethylene resin, polypropylene resin, silicone resin, fluoropolymers, acrylonitrile butadiene styrene resin, urethane resin and the like. Among these, polycarbonate resin and polyolefin resin are most preferably used for forming the support substrate 11 from the viewpoint of easy processing, optical characteristics and the like and in this embodiment, the support substrate 11 is formed of polycarbonate resin. In this embodiment, since the laser beam L is projected onto the recording layer 14via the light transmission layer 17 located opposite to the support substrate 11, it is unnecessary for the support substrate 11 to have a light transmittance property.

In this embodiment, the support substrate 11 has a thickness of about 1.1 mm.

As shown in FIG. 2, grooves 11a and lands 11b are alternately and spirally formed on the surface of the support substrate 11. The grooves 11a and/or lands 11b serve as a guide track for the laser beam L when data are to be recorded in the optical recording medium 10 or when data are to be reproduced from the optical recording medium 10.

The depth of the groove 11a is not particularly limited and is preferably set to 10 nm to 40 nm. The pitch of the grooves 11a is not particularly limited and is preferably set to 0.2 μm to 0.4 μm.

It is preferable to fabricate the support substrate 11 by an injection molding process using a stamper but the support substrate 11 may be fabricated using another process such as a 2P process.

The reflective layer 12 serves to reflect the laser beam L entering through the light incidence plane 17a so as to emit it from the light incidence plane 17a and effectively radiate heat generated in the recording layer 14 by the irradiation with the laser beam L. Further, the reflective layer 12 serves to increase a reproduced signal (C/N ratio) by a multiple interference effect.

In this embodiment, the reflective layer 12 is formed of Ag or alloy containing 90 atomic % or more of Ag, thereby improving the reflection coefficient thereof and a property thereof for radiating heat generated in the recording layer 14.

It is preferable to form the reflective layer 12 to have a thickness of 20 to 200 nm and is more preferable to form it to have a thickness of 7 to 150 nm.

In the case where the thickness of the reflective layer 12 is thinner than 20 nm, the above described effects cannot sufficiently be obtained. On the other hand, in the case where the thickness of the reflective layer 12 exceeds 200 nm, the surface smoothness of the reflective layer 12 is degraded and it takes a longer time for forming the reflective layer 12, thereby lowering the productivity of the optical recording medium 10.

The recording layer 14 is a layer in which record marks are to be formed, whereby data are recorded. The recording layer 14 is formed of a phase change material.

The reflection coefficients of the phase change material are different between the case where the phase change material is in a crystal phase and the case where it is in an amorphous phase, and data are recorded utilizing this characteristic of the phase change material.

When the laser beam L is projected onto the recording layer 14, whereby the phase of a region of the recording layer 14 is changed from a crystal phase to an amorphous phase to form a record mark, the laser beam L set to the recording power Pw is projected onto the recording layer 14 via the light transmission layer 17 to heat the region of the recording layer 14 irradiated with the laser beam L to a temperature equal to or higher than the melting point of the phase change material, thereby melting it and the laser beam L set to the bottom power Ph lower than the recording power Pw is then projected onto the recording layer 14, thereby quickly cooling the melted region of the recording layer 14 to change the phase thereof to an amorphous phase. Thus, a record mark is formed at the region of the recording layer 14 whose phase is in an amorphous phase.

Data are constituted by the length of the record mark and the length of the blank region between the record mark and the neighboring record mark in the direction of the track.

The length of the record mark and that of the blank region are each determined to be an integral multiple of T, where T is a length corresponding to one cycle of a reference clock and in the 1,7RLL Modulation Code, a record mark and a blank region having a length of 2T to 8T are used.

On the other hand, when the region of the recording layer 14 in an amorphous phase is crystallized, thereby erasing the record mark, the laser beam L set to the erasing power Pe equal to or higher than the bottom power Ph and lower than the recording power Pw is projected onto the recording layer 14 via the light transmission layer 17 to heat the region of the recording layer 14 to a temperature equal to or higher than the crystallization temperature of the phase change material and the region of the recording layer 14 is gradually cooled by moving the laser beam L away therefrom. Thus, the region of the recording layer 14 is crystallized and the record mark is erased.

Therefore, it is possible by modulating the power of the laser beam L projected onto the recording layer 14 to form a record mark in the recording layer 14 and directly overwrite a record mark formed in the region of the recording layer 14.

In this embodiment, the recording layer 14 contains a phase change material represented by an atomic composition formula: SbₐTe_{b}Ge_{c}Tb_{d} in an amount equal to or more than 95 atomic % where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9.

In a study done by the inventors of the present invention, it was found that the phase change material represented by the above atomic composition formula: SbₐTe_{b}Ge_{c}Tb_{d} had an extremely high crystallization speed and, therefore, in the case where an optical recording medium 10 included a recording layer 14 containing the phase change material in an amount equal to or more than 95 atomic %, data recorded in the recording layer 14 of the optical recording medium 10 could be overwritten at an extremely high linear velocity, for example, a linear velocity equal to or higher than 14 m/sec and equal to or lower than 33 m/sec.

In a further study done by the inventors of the present invention, it was found that since the phase change material had a relatively high crystallization temperature and the thermal stability thereof in an amorphous phase was high, an optical recording medium 10 that included a recording layer 14 containing the phase change material in an amount equal to or more than 95 atomic % was improved in data reproduction durability and storage reliability.

In a study done by the inventors of the present invention, it was found that in the case where a was smaller than 63, c was larger than 10, d was smaller than 3, d was larger than 15, (a+d) was is smaller than 75, or a/b was smaller than 3.3, the crystallization temperature of the phase change material became too low and it was difficult to crystallize the phase change material to erase a record mark and that, on the other hand, in the case where a was larger than 78, (a+d) was is larger than 82, or a/b was larger than 4.9, since the crystallization temperature of the phase change material became too high, it was difficult to change the phase of the phase change material from the crystalline phase to the amorphous phase to form a record mark and the thermal stability of the phase change material was decreased.

Further, the inventors of the present invention found that in the case where c was smaller than 2, since the content of Ge became too small, the crystallization speed became too low and the data reproduction durability and the storage reliability of the optical recording medium 10 were lowered.

In this embodiment, in order to control the crystallization temperature of the phase change material, the recording layer 14 may contain elements other than Sb, Te, Ge and Th, such as Ag, In or the like, in an amount equal to or less than 5 atomic % and may further contain unavoidable impurities.

Since the recording sensitivity decreases as the recording layer 14 becomes thicker, it is preferable to form the recording layer 14 to be thin. However, when the recording layer 14 is too thin, the difference in the optical constants between before and after data recording becomes small and a reproduced signal having a high level (C/N ratio) cannot be obtained. On the other hand, when the recording layer 14 is too thin, since the crystallization speed becomes markedly low, it is difficult to directly overwrite data and it is difficult to control the thickness of the recording layer 14 when it is formed. Therefore, the recording layer 14 is preferably formed to have a thickness of 2 to 40 nm, more preferably, to have a thickness of 4 to 30 nm and most preferably to have a thickness of 5 to 20 nm.

The heat radiation layer 16, the first dielectric layer 15 and the second dielectric layer 13 serve to physically and chemically protect the recording layer 14 and to increase the difference in the optical characteristics between before and after data recording. It is possible to effectively prevent data recorded in the recording layer 14 from being degraded for a long time by sandwiching the recording layer 14 by the first dielectric layer 15 and the second dielectric layer 13. In addition, the heat radiation layer 16 serves to quickly radiate heat generated in the recording layer 14.

The material usable for forming the second dielectric layer 13 is not particularly limited insofar as it is transparent with respect to the laser beam L and it is preferable to form the second dielectric layer 13 of a mixture of ZnS and SiO₂. The mole ratio of ZnS to SiO₂ is preferably 40:60 to 60:40 and the mole ratio of ZnS to SiO₂ is most preferably about 50:50, since the mixture of ZnS and SiO₂ whose mole ratio of ZnS to SiO₂ is about 50:50 is chemically stable and has an excellent property for protecting the recording layer 14 when the second dielectric layer 13 is formed thereof.

The thickness of the second dielectric layer 13 is not particularly limited but the second dielectric layer 13 is preferably formed to have a thickness of 3 nm to 14 nm. In the case where the thickness of the second dielectric layer 13 is thinner than 3 nm, it becomes difficult to protect the recording layer 14 in a desired manner and, on the other hand, in the case where the thickness of the second dielectric layer 13 exceeds 14 nm, there is a risk of cracks being generated in the second dielectric layer 13 due to internal stress and the heat radiation effect thereof becomes low.

On the other hand, the material for forming the first dielectric layer 15 on side of the light incidence plane 17a with respect to the recording layer 14 is not particularly limited but the first dielectric layer 15 is preferably formed of a mixture of ZnS and SiO₂. The mole ratio of ZnS to SiO₂ is preferably 70:30 to 90:10 and most preferably about 80:20. It is possible by forming the first dielectric layer 15 of such a material to improve the characteristics for protecting the recording layer 14 and effectively prevent the recording layer 14 from being deformed by heat generated when data are recorded therein. The thus formed first dielectric layer 15 has an excellent optical characteristic with respect to the laser beam L having a wavelength included in a blue wavelength region.

The thickness of the first dielectric layer 15 is not particularly limited but the first dielectric layer 15 is preferably formed to have a thickness of 10 nm to 60 nm and more preferably formed to have a thickness of 10 nm to 40 nm. In the case where the thickness of the first dielectric layer 15 is thinner than 10 nm, it becomes difficult to protect the recording layer 14 in a desired manner and on the other hand, in the case where the thickness of the first dielectric layer 15 exceeds 60 nm, the heat radiation effect of the heat radiation layer 16 becomes low.

The material for forming the heat radiation layer 16 is not particularly limited but the heat radiation layer 16 is preferably formed of the material containing 90 atomic % or more of aluminum nitride. Since aluminum nitride has high thermal conductivity, when the heat radiation layer 16 is formed of the material containing 90 atomic % or more of aluminum nitride, it is possible to effectively radiate heat generated in the recording layer 14. Since the thermal conductivity of the heat radiation layer 16 increases as the amount of aluminum nitride contained in the heat radiation layer 16 increases, it is more preferable for the heat radiation layer 16 to contain 95 atomic % or more of aluminum nitride.

The thickness of the heat radiation layer 16 is not particularly limited but it is preferable to form the heat radiation layer 16 to have a thickness of 50 nm to 150 nm and is more preferable to form the heat radiation layer 16 to have a thickness of 80 nm to 120 nm. In the case where the thickness of the heat radiation layer 16 is thinner than 50 nm, sufficient heat radiation characteristics cannot be obtained and, on the other hand, in the case where the thickness of the heat radiation layer 16 exceeds 150 nm, it takes much time to form the heat radiation layer 16, thereby lowering the productivity of the optical recording medium 10 and giving rise to a risk of cracks being generated in the heat radiation layer 16 due to internal stress.

In the case where the first dielectric layer 15 and the heat radiation layer 16 are integrated and formed of the material containing 90 atomic % or more of aluminum nitride, it is possible to much more effectively radiate heat generated in the recording layer 14. However, in the case where a layer integrated by the first dielectric layer 15 and the heat radiation layer 16 is formed of the material containing 90 atomic % or more of aluminum nitride, since the adhesiveness between itself and the recording layer 14 is low, the data overwriting characteristics are lowered if the layer is brought into direct contact with the recording layer 14, and since aluminum nitride has little enhancement effect, sufficient modulation cannot be obtained, whereby the jitter characteristics are lowered. Therefore, in this embodiment, the first dielectric layer 15 and the heat radiation layer 16 are separately provided.

Each of the reflective layer 12, the second dielectric layer 13, the recording layer 14, the first dielectric layer 15 and the heat radiation layer 16 can be formed using a gas phase growth process using chemical species containing elements for forming it. As the gas phase growth process, a sputtering process is preferably used.

The light transmission layer 17 serves to transmit the laser beam L and the light incidence plane 17a is constituted by the surface thereof.

It is preferable to form the light transmission layer 17 to have a thickness of 10 μm to 300 μm and is more preferable to form the light transmission layer 17 to have a thickness of 50 μm to 150 μm.

The material usable for forming the light transmission layer 17 is not particularly limited insofar as it has a sufficiently high light transmittance with respect to the laser beam L but it is preferable to form the light transmission layer 17 by applying acrylic ultraviolet ray curable resin or epoxy ultraviolet ray curable resin onto the surface of the heat radiation layer 16 using a spin coating process.

The light transmission layer 17 may be formed by adhering a sheet made of light transmittable resin to the surface of the heat radiation layer 16 using an adhesive agent.

When data are to be recorded in the thus constituted optical recording medium 10, a laser beam L whose power is set to the recording power Pw is projected onto the recording layer 14 via the light transmission layer 17 to heat a region of the recording layer 14 irradiated with the laser beam L to a temperature equal to or higher than the melting point of the phase change material, thereby melting it.

The laser beam L whose power is set to the bottom power Pb lower than the recording power Pw is then projected onto the recording layer 14, thereby quickly cooling the melted region of the recording layer 14 to change the phase thereof to an amorphous phase.

Thus, a record mark is formed in the recording layer 14 and data are recorded therein.

Since the reflection coefficients of the phase change material are different between the case where the phase change material is in a crystal phase and the case where it is in an amorphous phase, data can be reproduced utilizing these characteristics of the phase change material.

On the other hand, when a record mark formed in the recording layer 14 is to be erased, the laser beam L whose power is set to the erasing power Pe equal to or higher than the bottom power Pb is projected onto a region of the recording layer 14 where the record mark is formed via the light transmission layer 17 to heat the region of the recording layer 14 irradiated with the laser beam L to a temperature equal to or higher than the crystallization temperature of the phase change material Then, the region of the recording layer 14 is gradually cooled by moving the laser beam L away therefrom.

Thus, the phase change material contained is crystallized and the record mark which was formed at the region of the recording layer 14 is erased.

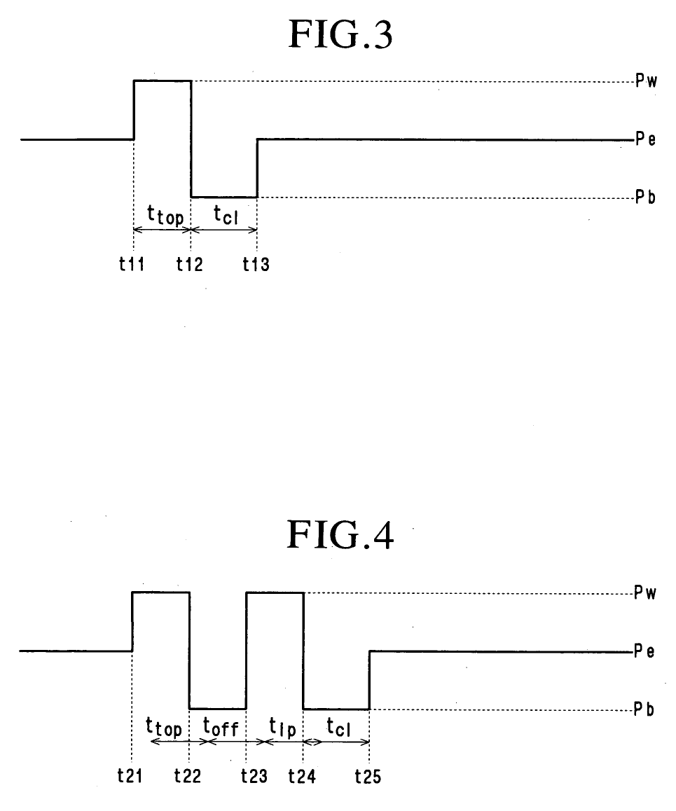

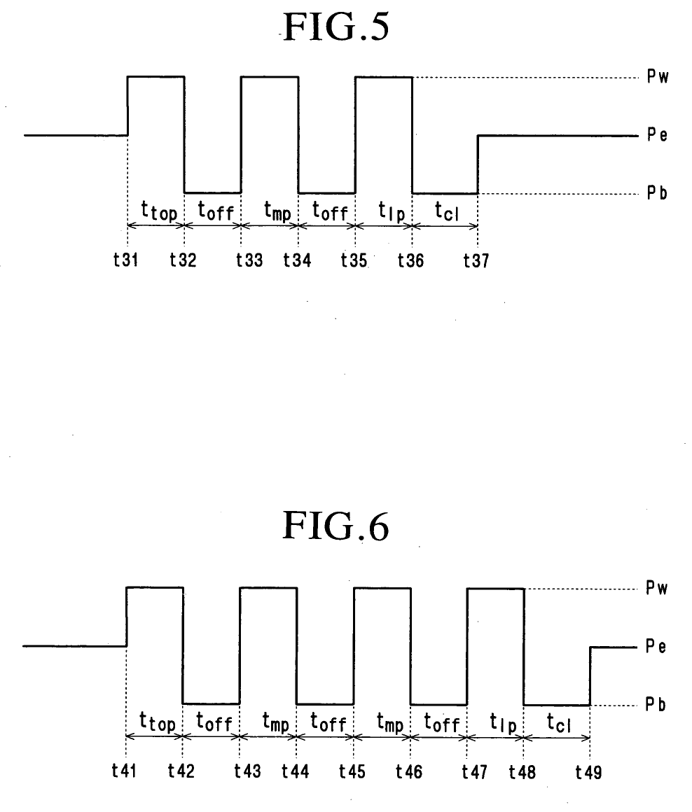

Each of FIGS. 3 to 6 is a diagram showing the waveform of a pulse train pattern for modulating the power of the laser beam L in the case of recording data in the recording layer 14 of the thus constituted optical recording medium 10, where FIG. 3 shows a pulse train pattern used in the case of recording a 2T signal or a 3T signal, FIG. 4 shows a pulse train pattern used in the case of recording a 4T signal or a 5T signal, FIG. 5 shows a pulse train pattern used in the case of recording a 6T signal or a 7T signal and FIG. 6 shows a pulse train pattern used in the case of recording an 8T signal.

As shown in FIGS. 3 to 6, the power of the laser beam L is modulated between three levels, a recording power Pw, an erasing power Pe and a bottom power Ph where Pw>Pe>Ph.

The recording power Pw is set to such a high level that the phase change material contained in the recording layer 14 is heated to a temperature higher than the melting point thereof when the laser beam L whose power is set to the recording power Pw is projected onto the recording layer 14 and on the other hand, the erasing power Pe is set to such a level that the phase change material contained in the recording layer 14 is heated to a temperature equal to or higher than the crystallization temperature thereof when the laser beam L whose power is set to the recording power Pe is projected onto the recording layer 14. To the contrary, the bottom power Ph is set to such a low level that regions of the recording layer 14 heated by irradiation with the laser beam L whose power is set to the recording power Pw can be cooled by irradiation with the laser beam L whose power is set to the bottom power Ph.

Since the ratio Pe/Pw of the erasing power Pe to the recording power Pw greatly influences the data direct overwriting characteristics of the optical recording medium 10, it is preferable to determine it depending upon the linear recording velocity of data. More specifically, it is preferable to set the recording power Pw high and the ratio Pe/Pw of the erasing power Pe to the recording power Pw smaller as the linear recording velocity of data is higher and it is further preferable to set the level of the erasing power Pe to be lower as the linear recording velocity of data is higher. Therefore, in this embodiment, the ratio Pe/Pw is set to be equal to or larger than 0.26 and equal to or smaller than 0.70 and preferably set to be equal to or larger than 0.26 and equal to or smaller than 0.65.

In a study done by the inventors of the present invention, it was found that in the case where the recording power Pw was high and the ratio Pe/Pw of the erasing power Pe to the recording power Pw was set in this manner, it was possible not only to form a record mark having a good shape but also to erase a record mark efficiently, thereby ensuring good data direct overwriting characteristics.

As shown in FIG. 3, in the case of recording a 2T signal or a 3T signal in the recording layer 14 of the optical recording medium 10, the power of the laser beam L is modulated so that it is increased from the erasing power Pe to the recording power Pw at a time t11, decreased from the recording power Pw to the bottom power Pb at a time t12 after passage of a predetermined time period tₜₒₚ, and increased from the bottom power Pb to the erasing power Pe at a time t13 after passage of a predetermined cooling time period t_{cl}.

Therefore, in the case of recording a 2T signal or a 3T signal in the recording layer 14 of the optical recording medium 10, the number of pulses having a level equal to the recording power Pw, namely, the recording pulse number is set to be 1.

On the other hand, as shown in FIG. 4, in the case of recording a 4T signal or a 5T signal in the recording layer 14 of the optical recording medium 10, the power of the laser beam L is modulated so that it is increased from the erasing power Pe to the recording power Pw at a time t21, decreased from the recording power Pw to the bottom power Pb at a time t22 after passage of a predetermined time period tₜₒₚ, increased from the bottom power Pb to the recording power Pw at a time t23 after passage of a predetermined time period t_{off}, decreased from the recording power Pw to the bottom power Pb at a time t24 after passage of a predetermined time period tₗₚ and increased from the bottom power Pb to the erasing power Pe at a time t25 after passage of a predetermined cooling time period t_{cl}.

Therefore, in the case of recording a 4T signal or 5T signal in the recording layer 14 of the optical recording medium 10, the number of pulses each having a level equal to the recording power Pw, namely, the recording pulse number is set to be 2.

Further, as shown in FIG. 5, in the case of recording a 6T signal or a 7T signal in the recording layer 14 of the optical recording medium 10, the power of the laser beam L is modulated so that it is increased from the erasing power Pe to the recording power Pw at a time t31, decreased from the recording power Pw to the bottom power Pb at a time t32 after passage of a predetermined time period tₜₒₚ, increased from the bottom power Pb to the recording power Pw at a time t33 after passage of a predetermined time period t_{off}, decreased from the recording power Pw to the bottom power Pb at a time t34 after passage of a predetermined time period tₘₚ, increased from the bottom power Pb to the recording power Pw at a time t35 after passage of a predetermined time period t_{off}, decreased from the recording power Pw to the bottom power Pb at a time t36 after passage of a predetermined time period tₗₚ and increased from the bottom power Pb to the erasing power Pe at a time t37 after passage of a predetermined cooling time period t_{cl}.

Therefore, in the case of recording a 6T signal or a 7T signal in the recording layer 14 of the optical recording medium 10, the number of pulses each having a level equal to the recording power Pw, namely, the recording pulse number is set to be 3.

Moreover, as shown in FIG. 6, in the case of recording an 8T signal in the recording layer 14 of the optical recording medium 10, the power of the laser beam L is modulated so that it is increased from the erasing power Pe to the recording power Pw at a time t41, decreased from the recording power Pw to the bottom power Pb at a time t42 after passage of a predetermined time period tₜₒₚ, increased from the bottom power Pb to the recording power Pw at a time t43 after passage of a predetermined time period t_{off}, decreased from the recording power Pw to the bottom power Pb at a time t44 after passage of a predetermined time period tₘₚ, increased from the bottom power Pb to the recording power Pw at a time t45 after passage of a predetermined time period t_{off}, decreased from the recording power Pw to the bottom power Pb at a time t46 after passage of a predetermined time period tₘₚ, increased from the bottom power Pb to the recording power Pw at a time t47 after passage of a predetermined time period t_{off}, decreased from the recording power Pw to the bottom power Pb at a time t48 after passage of a predetermined time period tₗₚ and increased from the bottom power Pb to the erasing power Pe at a time t49 after passage of a predetermined cooling time period t_{cl}.

Therefore, in the case of recording an 8T signal in the recording layer 14 of the optical recording medium 10, the number of pulses each having a level equal to the recording power Pw, namely, the recording pulse number is set to be 4.

When the recording layer 14 is irradiated with the laser beam L set to the recording power Pw, the phase change material contained in the recording layer 14 is heated to a temperature higher than the melting point thereof at a region of the recording layer 14 irradiated with the laser beam L, and when it is irradiated with the laser beam L set to the bottom power Pb, the melted phase change material is quickly cooled and the phase of the phase change material is changed to the amorphous phase, whereby a record mark is formed and data are recorded in the recording layer 14.

Since the reflective coefficient with respect to a laser beam L of a region of the recording layer 14 where the record mark is formed in this manner and that of a region where no record mark is formed, namely, a blank region, are greatly different, data recorded in the recording layer 14 can be reproduced utilizing the difference in the reflection coefficients between the region of the recording layer 14 where the record mark is formed and the blank region.

The length of the record mark and the length of the blank region between the record mark and the neighboring record mark constitute data recorded in the recording layer 14. The record mark and the blank region are formed so as to have a length equal to an integral multiple of T, where T is a length corresponding to one cycle of a reference clock. In the case where 1,7 RLL modulation code is employed, record marks and blank regions having a length of 2T to 8T are formed.

On the other hand, when a region of the recording layer 14 where a record mark is formed is irradiated with a laser beam L whose power is set to the recording power Pe, the region of the recording layer 14 irradiated with the laser beam L is heated to a temperature equal to or higher than the crystallization temperature of the phase change material and when the laser beam L is moved away from the region of the recording layer 14, the region of the recording layer 14 is gradually cooled.

Thus, the phase change material contained is crystallized and the record mark which was formed at the region of the recording layer 14 is erased.

Therefore, data recorded in the recording layer 14 can be directly overwritten by modulating the power of the laser beam L between the recording power Pw, the erasing power Pe and the bottom power Ph.

As shown in FIGS. 3 to 6, in this embodiment, in the case where a record mark having a length nT is to be formed in the recording layer 14 where n is an integer equal to or larger than 2 and T is a length corresponding to one cycle of a reference clock, when n is an even number, the recording pulse number is set to be n/2 and when n is an odd number, the recording pulse number is set to be (n-1)/2, and since the recording number used for forming one record mark is less than that in an ordinary divided pulse modulation method, the length of the period during which the power of the laser beam L is set to the recording power Pw is longer than that in an ordinary divided pulse modulation method. Therefore, even in the case where data are recorded at an extremely high linear recording velocity, it is possible to form a record mark having a good shape in the recording layer because the temperature of the recording layer 14 can be accurately controlled.

Further, in the case where data are recorded at a linear recording velocity of 14 m/sec using a divided pulse modulation method in which the recording pulse number is set to (n-1) for forming a record mark having a length of nT, the fact that the shortest pulse width is equal to about 1.7 nsec makes it impossible to modulate the power of a laser beam L in accordance with such a pulse train pattern even if a high speed laser driver is used. However, in this embodiment, since the pulse width is equal to about 4.0 nanosec at minimum, it is possible to modulate the power of a laser beam L in accordance with a corresponding pulse train pattern in a desired manner even in the case where data are recorded at a high linear recording velocity.

In this embodiment, a preferred range of the linear recording velocity to be set when data are recorded in the optical recording medium 10, the pulse train patterns shown in FIGS. 3 to 6 and a preferred range of the ratio Pe/Pw of the erasing power Pe to the recording power Pw of a laser beam L to be used for modulating the power of the laser beam L when data are recorded in the optical recording medium 10 are recorded as data for setting recording conditions in the optical recording medium 10 in the form of wobbles or pre-pits and when data are to be recorded in the optical recording medium 10, the data recording apparatus reads the data for setting recording conditions recorded in the optical recording medium 10 and determines conditions for recording data based on the thus read data for setting recording conditions in accordance with a program for setting recording conditions.

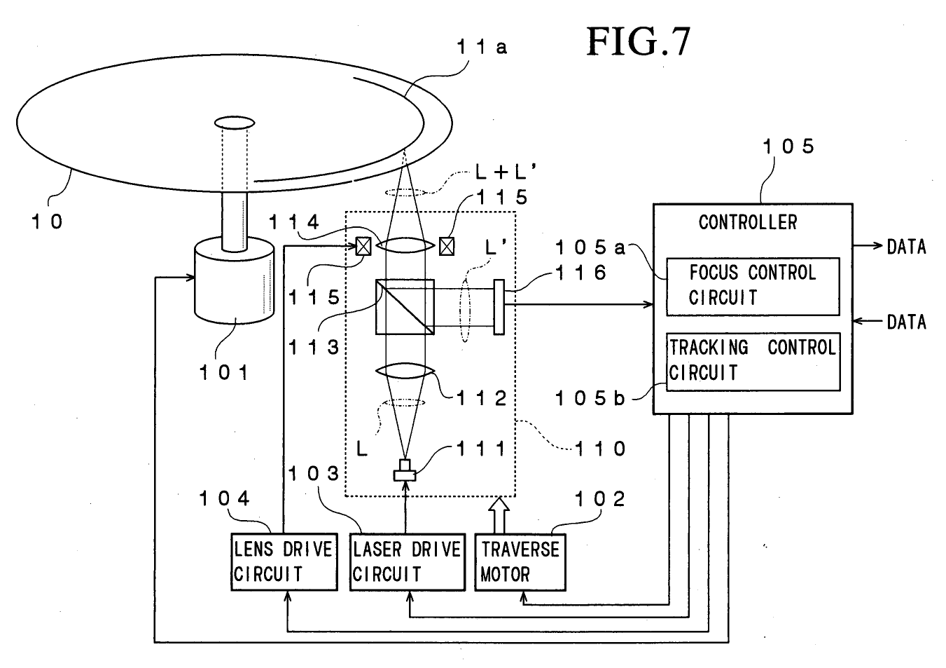

FIG. 7 is a diagram showing a data recording apparatus for recording data in the optical recording medium 10.

As shown in FIG. 7, a data recording apparatus 100 includes a spindle motor 101 for rotating the optical recording medium 10, an optical head 110 for projecting a laser beam L onto the optical recording medium 10 and receiving the laser beam L′ reflected by the optical recording medium 10, a traverse motor 102 for moving the optical head 110 in a radial direction of the optical recording medium 10, a laser drive circuit 103 for feeding a laser drive signal 103a to the optical head 110, a lens drive circuit 104 for feeding a lens drive signal 104a to the optical head 110, and a controller 105 for controlling the spindle motor 101, the traverse motor 102, the laser drive circuit 103 and the lens drive circuit 104.

The optical head 110 includes a laser beam source 111 for emitting the laser beam L based on the laser drive signal 103a, a collimator lens 112 for making the laser beam L emitted from the laser beam source 111 a parallel beam, a beam splitter 113 disposed in the optical path of the laser beam L, an objective lens 105 for condensing the laser beam L, an actuator 106 for moving the objective lens 105 in the vertical direction and the horizontal direction based on the lens drive signal 104a, and a photodetector 116 for receiving the laser beam L′ reflected by the optical recording medium 10 and photoelectrically converting it.

The spindle motor 101 is controlled by the controller 105 so as to rotate the optical recording medium 10 at a desired speed of rotation.

The methods for controlling the rotation of the optical recording medium 10 are roughly classified into the CLV method of rotating the optical recording medium 10 while keeping the linear velocity constant and the CAV method of rotating the optical recording medium 10 while keeping the angular velocity constant.

In the case where the rotation of the optical recording medium 10 is controlled using the CLV method, since the data transfer rate can be kept constant irrespective of the position in the radial direction of the optical recording medium 10 where data are being recorded or data are being reproduced, data can be recorded in or data can be reproduced from the optical recording medium 10 at a high transfer rate at all times, so that data can be recorded at high density. On the other hand, however, since the speed of rotation of the optical recording medium 10 has to be changed in accordance with the position in the radial direction of the optical recording medium 10 where data are being recorded or data are being reproduced, it is necessary to control the spindle motor 101 in a complicated manner and, therefore, the random access speed is low.

To the contrary, in the case where the rotation of the optical recording medium 10 is controlled using the CAV method, since the spindle motor 101 can be controlled in a simple manner, the random access speed is high. On the other hand, however, the CAV method is disadvantageous in that the data recording density at the outer circumference portion of the optical recording medium 10 becomes slightly lower.

The traverse motor 102 is controlled by the controller 105 so as to move the optical head 110 in the radial direction of the optical recording medium 10 and when data are to be recorded in the optical recording medium 10 or data are to be reproduced from the optical recording medium 10, it moves the optical head 110 so that the spot of the laser beam L gradually moves along the groove 11b spirally formed on the optical recording medium 10 from the inner circumference portion to the outer circumference portion of the optical recording medium 10.

In the case of changing the position in the radial direction of the optical recording medium 10 where data are to be recorded or data are to be reproduced, the controller 105 controls the traverse motor 102 to move the spot of the laser beam L to the desired position on the optical recording medium 10.

The laser drive circuit 103 is controlled by the controller 105 so as to feed a laser drive signal 103a to the laser beam source 111 of the optical head 110. The laser beam source 111 generates a laser beam L whose power corresponds to the laser drive signal 103a fed from the laser drive circuit 103.

When data are to be recorded in the optical recording medium 10, the laser drive circuit 103 generates a laser drive signal 103a whose intensity is modulated so that the power of the laser beam L can be modulated in accordance with the above described pulse pattern and feeds it to the laser beam source 111 of the optical head 110. On the other hand, when data are to be reproduced from the optical recording medium 10, the laser drive circuit 103 generates a laser drive signal having a constant intensity and feeds it to the laser beam source 111 of the optical head 110, thereby causing the laser beam source 111 to emit a laser beam L having a reproduction power Pr of a constant level.

The lens drive circuit 104 is controlled by the controller 105 so as to feed a lens drive signal to the actuator 115.

The controller 105 is provided with a focus control circuit 105a and when the focus control circuit 105a is turned on, the spot of the laser beam L is focused on the recording layer 14 of the optical recording medium 10 and fixed thereon. The controller is further provided with a tracking control circuit 105b and when the tracking control circuit 105b is turned on, the spot of the laser beam L automatically follows the groove 11b of the optical recording medium 10. Therefore, it is possible for the spot of the laser beam L to be correctly focused on the recording layer 14 of the optical recording medium 10 and to follow the groove 11b of the optical recording medium 10.

In this embodiment, the controller 105 of the data recording apparatus 100 further includes a memory (not shown) and programs for setting recording conditions are stored in the memory.

The thus constituted data recording apparatus 100 records data in the optical recording medium 10 in the following manner.

When the optical recording medium 10 is set in the data recording apparatus, the controller 105 of the data recording apparatus reads the data for setting recording conditions recorded in the optical recording medium 10 and also reads the program for setting recording conditions stored in the memory.

In this embodiment, in accordance with the composition of the phase change material contained in the recording layer 14 of the optical recording medium 10 and represented by the atomic composition formula: SbₐTe_{b}Ge_{c}Tb_{d}, a preferred range of a linear recording velocity to be set when data are recorded in the optical recording medium 10, the pulse train patterns shown in FIGS. 3 to 6 and a preferred range of the ratio Pe/Pw of the erasing power Pe to the recording power Pw of a laser beam L to be used for modulating the power of the laser beam L when data are recorded in the optical recording medium 10 are determined as data for setting recording conditions and recorded in the optical recording medium 10 in the form of wobbles or pre-pits. Therefore, the controller 105 performs test recording of data on a predetermined track of the optical recording medium 10 based on the thus read data for setting recording conditions in accordance with the program for setting recording conditions read from the memory, thereby determining the recording conditions of data, namely, the linear recording velocity of data, the width of each pulse of the pulse train pattern for modulating the power of a laser beam L and the ratio Pe/Pw of the erasing power Pe to the recording power Pw of a laser beam L.

The controller 105 then produces a data conditions setting signal based on the thus determined the recording conditions of data and outputs it to the laser drive circuit 103.

The laser drive circuit 103 generates a laser drive signal based on the input data conditions setting signal and outputs it to the laser beam source 111 of the optical head 110, while it outputs control signals to the spindle motor 101 and the traverse motor 102.

As a result, a laser beam L whose power is modulated by the pulse train pattern determined based on the data conditions setting signal is emitted from the laser beam source 111 and the laser beam L passes through the collimator lens 112 to be made a parallel beam.

The laser beam L then enters the objective lens 114 via the beam splitter 113 and is converged onto the groove 11b formed on the optical recording medium 10.

At this time, the optical recording medium 10 is rotated by the spindle motor 101 at a linear velocity equal to the linear recording velocity determined based on the data conditions setting signal and therefore, data are recorded in the recording layer 14 of the optical recording medium 10 under desired recording conditions.

To the contrary, when data recorded in the optical recording medium 10 are to be reproduced, the controller 105 causes the laser drive circuit 103 to output a laser drive signal 103a having a predetermined intensity to the laser beam source 111, thereby causing the laser beam source 111 to emit a laser beam L having a reproduction power Pr of a predetermined level.

The laser beam L emitted from the laser beam source 111 is projected onto the recording layer 14 of the optical recording medium 10 and reflected by the recording layer 14 of the optical recording medium 10.

The laser beam L′ reflected by the recording layer 14 of the optical recording medium 10 is made a parallel beam by the objective lens 114 and reflected by the beam splitter 113.

The laser beam L′ reflected by the beam splitter 113 impinges on the photodetector 116 to be photoelectrically detected thereby and the thus produced data are output to the controller 105.

### WORKING EXAMPLES

Hereinafter, working examples will be set out in order to further clarify the advantages of the present invention.

### Working Example 1

An optical recording medium sample # 1 was fabricated in the following manner.

A substrate of polycarbonate having a thickness of 1.1 mm and a diameter of 120 mm and formed with grooves and lands on the surface thereof was first fabricated by an injection molding process.

Then, the substrate was set on a sputtering apparatus and a reflective layer consisting of an alloy containing 90 atomic % or more of Ag and added with Pd and Cu and having a thickness of 100 nm, a second dielectric layer consisting of a mixture of ZnS and SiO₂ and having a thickness of 4 nm, a recording layer containing 74.0 atomic % of Sb, 16.7 atomic % of Te, 4.7 atomic % of Ge, 3.7 atomic % of Tb and 0.9 atomic % of In and having a thickness of 14 nm, a first dielectric layer consisting of the mixture of ZnS and SiO₂ and having a thickness of 30 nm and a heat radiation layer containing 90 atomic % of more of aluminum nitride and having a thickness of 100 nm were sequentially formed on the surface of the substrate on which the grooves and lands were formed, using the sputtering process.

The mole ratio of ZnS to SiO₂ in the mixture of ZnS and SiO₂ contained in the first dielectric layer was 80:20 and the mole ratio of ZnS to SiO₂ in the mixture of ZnS and SiO₂ contained in the second dielectric layer was 50:50.

Further, the support substrate formed with the reflective layer, the second dielectric layer, the recording layer, the first recording layer and the heat radiation layer on the surface there of was set on a spin coating apparatus and the heat radiation layer was coated with a resin solution prepared by dissolving acrylic ultraviolet curing resin in a solvent to form a coating layer and the coating layer was irradiated with ultraviolet rays, thereby curing the acrylic ultraviolet curing resin to form a protective layer having a thickness of 100 μm.

Thus, the optical recording medium sample # 1 was fabricated.

Further, an optical recording medium sample #2 was fabricated in the manner of the optical recording medium sample # 1 except that a recording layer containing 72.6 atomic % of Sb, 16.4 atomic % of Te, 4.5 atomic % of Ge, 5.7 atomic % of Tb and 0.9 atomic % of In was formed.

Then, an optical recording medium sample #3 was fabricated in the manner of the optical recording medium sample # 1 except that a recording layer containing 70.2 atomic % of Sb, 15.9 atomic % of Te, 3.8 atomic % of Ge, 9.2 atomic % of Tb and 0.9 atomic % of In was formed.

Further, an optical recording medium sample #4 was fabricated in the manner of the optical recording medium sample # 1 except that a recording layer containing 68.1 atomic % of Sb, 15.6 atomic % of Te, 3.1 atomic % of Ge, 12.4 atomic % of Tb and 0.8 atomic % of In was formed.

Then, an optical recording medium sample #5 was fabricated in the manner of the optical recording medium sample # 1 except that a recording layer containing 67.1 atomic % of Sb, 15.4 atomic % of Te, 2.8 atomic % of Ge, 13.9 atomic % of Tb and 0.8 atomic % of In was formed.

Further, an optical recording medium sample #6 was fabricated in the manner of the optical recording medium sample # 1 except that a recording layer containing 72.6 atomic % of Sb, 16.4 atomic % of Te, 4.5 atomic % of Ge, 5.7 atomic % of Tb and 0.9 atomic % of In was formed.

Then, an optical recording medium comparative sample #1 was fabricated in the manner of the optical recording medium sample # 1 except that a recording layer containing 64.8 atomic % of Sb, 14.9 atomic % of Te, 2.1 atomic % of Ge, 17.3 atomic % of Tb and 0.8 atomic % of In was formed.

Further, an optical recording medium comparative sample #2 was fabricated in the manner of the optical recording medium sample # 1 except that a recording layer containing 74.8 atomic % of Sb, 16.8 atomic % of Te, 5.2 atomic % of Ge, 2.3 atomic % of Tb and 0.9 atomic % of In was formed.

Then, an optical recording medium comparative sample #3 was fabricated in the manner of the optical recording medium sample # 2 except that a second dielectric layer having a thickness of 16 nm was formed.

Further, an optical recording medium comparative sample #4 was fabricated in the manner of the optical recording medium sample # 2 except that a second dielectric layer having a thickness of 2 nm was formed.

Then, an optical recording medium comparative sample #5 was fabricated in the manner of the optical recording medium sample # 1 except that a recording layer containing 65.5 atomic % of Sb, 21.8 atomic % of Te, 5.4 atomic % of Ge, 7.3 atomic % of Tb was formed.

Further, an optical recording medium comparative sample #6 was fabricated in the manner of the optical recording medium sample # 1 except that a recording layer containing 76.6 atomic % of Sb, 13.2 atomic % of Te, 0.8 atomic % of Ge, 4.7 atomic % of Tb and 4.7 atomic % of In was formed.

Each of the optical recording medium samples #1 to #6 and the optical recording medium comparative samples #1 to #6 was set in an optical recording medium evaluation apparatus “DDU1000” (Product Name) manufactured by Pulstec Industrial Co., Ltd. and a laser beam having a wavelength λ of 405 nm was focused onto each of the recording layers using an objective lens whose numerical aperture was 0.85 via the light transmission layer while each sample was rotated at a linear velocity of 20.0 m/sec, thereby recording random signals including 2T signals to 8T signals in the 1,7 RLL Modulation Code therein.

The power of the laser beam was modulated in accordance with the pulse train patterns shown in FIGS. 3 to 6 wherein the recording power Pw of the laser beam was set to be 8.5 mW, the erasing power Pe of the laser beam was set to be 3.5 mW and the bottom power Ph of the laser beam was set to be 0.3 mW. Therefore, the ratio Pe/Pw of the erasing power Pe to the recording power Pw was 0.4.

Then, each of the optical recording medium samples #1 to #6 and the optical recording medium comparative samples #1 to #6 was set in the above mentioned optical recording medium evaluation apparatus and a laser beam having a wavelength λ of 405 nm was focused onto each of the recording layers using an objective lens whose numerical aperture was 0.85 via the light transmission layer while each sample was rotated at a linear velocity of 20.0 m/sec, thereby reproducing a signal recorded in the recording layer and clock jitter of the reproduced was measured.

The fluctuation σ of a reproduced signal was measured using a time interval analyzer and the clock jitter was calculated as σ/Tw, where Tw was one clock period.

Further, each of the optical recording medium samples #1 to #6 and the optical recording medium comparative samples #1 to #6 was set in the above mentioned optical recording medium evaluation apparatus and an 8T signal was recorded in a track of the recording layer of each sample other than the track in which the random signals were recorded in a manner similar to that of recording the random signals in each sample.

Then, each of the optical recording medium samples #1 to #6 and the optical recording medium comparative samples #1 to #6 was set in the above mentioned optical recording medium evaluation apparatus and the 8T signal recorded in the recording layer of each sample was reproduced and the carrier level C1 of the reproduced signal was measured.

Further, a direct current laser beam whose power was set to the same level as that of the erasing power Pe was projected onto the track of the recording layer of each of the optical recording medium samples #1 to #6 and the optical recording medium comparative samples #1 to #6 in which the 8T signal was recorded, thereby recording a signal therein and the recorded signal was reproduced to measure the carrier level C2 of the reproduced signal. Then, a data erasing efficiency defined by (C1-C2) was calculated.

Furthermore, each of the optical recording medium samples #1 to #6 and the optical recording medium comparative samples #1 to #6 was stored under a temperature of 80° C. for 50 hours, thereby performing a storage test. Then, the random signals recorded in each sample were reproduced and clock jitter of a reproduced signal was measured.

Then, clock jitter of the signals obtained by reproducing the random signals recorded in each of the optical recording medium samples #1 to #6 and the optical recording medium comparative samples #1 to #6 and the data erasing efficiency of each sample were rated and the storage reliability of each sample was rated based on clock jitter of the signals obtained by reproducing the random signals recorded in each sample after the storage test. The results of the rating are shown in Table 1.

Clock jitter of the signals obtained by reproducing the random signals recorded in each sample was rated GOOD when it was equal to or lower than 10%, the data erasing efficiency of each sample was rated as GOOD when it was equal to or higher than 25 dB and the storage reliability of each sample was rated GOOD when the increase in clock jitter between before and after the storage test was equal to or smaller than 1%. Otherwise, they were rated BAD.

TABLE 1

| | | Data erasing | |
|---|---|---|---|
| | Jitter | efficiency | Storage reliability |
| Sample #1 | GOOD | GOOD | GOOD |
| Sample #2 | GOOD | GOOD | GOOD |
| Sample #3 | GOOD | GOOD | GOOD |
| Sample #4 | GOOD | GOOD | GOOD |
| Sample #5 | GOOD | GOOD | GOOD |
| Sample #6 | GOOD | GOOD | GOOD |
| Comparative Sample #1 | GOOD | BAD | GOOD |
| Comparative Sample #2 | BAD | BAD | BAD |
| Comparative Sample #3 | GOOD | BAD | BAD |
| Comparative Sample #4 | GOOD | BAD | BAD |
| Comparative Sample #5 | BAD | BAD | BAD |
| Comparative Sample #6 | GOOD | GOOD | GOOD |

As shown in Table 1, it was found that clock jitter, the data erasing efficiency and the storage reliability were good in each of the optical recording medium samples #1 to #6.

To the contrary, it was found that in each of the optical recording medium comparative samples #1 to #6, clock jitter, the data erasing efficiency and the storage reliability could not be simultaneously improved.

The present invention has thus been shown and described with reference to specific embodiments. However, it should be noted that the present invention is in no way limited to the details of the described arrangements but changes and modifications may be made without departing from the scope of the appended claims.

For example, in the above described embodiment, the optical recording medium 10 includes the reflective layer 12, the second dielectric layer 13, the recording layer 14, the first dielectric layer 15, the heat radiation layer 16 and the light transmission layer 17 on the support substrate 11 in this order. However, in order to prevent the reflective layer 12 from being corroded, it is possible to form between the support substrate 11 and the reflective layer 12 a moisture-proof layer of oxide, sulfide, nitride or carbide of Al, Si, Ce, Ti, Zn, Ta or the like such as Al₂O₃, AlN, ZnO, ZnS, GeN, GeCrN, CeO₂, SiO, SiO₂, Si₃N₄, SiC, La₂O₃, TaO, TiO₂, SiAlON (mixture of SiO₂, Al₂O₃, Si₃N₄ and AlN), LaSiON (mixture of La₂O₃, SiO₂ and Si₃N) or the like. In the case where the moisture-proof layer is provided between the support substrate 11 and the reflective layer 12, it is preferable to form the moisture-proof layer of the mixture of ZnS and SiO₂.

Further, in the above described embodiment, although the optical recording medium 10 includes the reflective layer 12, the second dielectric layer 13, the recording layer 14, the first dielectric layer 15, the heat radiation layer 16 and the light transmission layer 17 on the support substrate 11 in this order, an interface layer may be formed between the recording layer 14 and the first dielectric layer 15 of the mixture of ZnS and SiO₂ whose mole ratio is 40:60 to 60:40, particularly, 50:50.

Furthermore, in the above described embodiment, although the optical recording medium 10 includes the reflective layer 12, the second dielectric layer 13, the recording layer 14, the first dielectric layer 15, the heat radiation layer 16 and the light transmission layer 17 on the support substrate 11 in this order, a hard coat layer may be formed on the surface of the light transmission layer 17 to protect the light transmission layer 17.

Moreover, in the above described embodiment, a preferred range of a linear recording velocity to be set when data are recorded in the optical recording medium 10, the pulse train pattern shown in FIGS. 3 to 6 and a preferred range of the ratio Pe/Pw of the erasing power Pe to the recording power Pw of a laser beam L to be used for modulating the power of the laser beam L when data are recorded in the optical recording medium 10 are recorded as data for setting recording conditions in the optical recording medium 10 in the form of wobbles or pre-pits and when data are to be recorded in the optical recording medium 10, the data recording apparatus reads the data for setting recording conditions recorded in the optical recording medium 10 and determines conditions for recording data based on the thus read data for setting recording conditions in accordance with a program for setting recording conditions. However, it is not absolutely necessary for the optical recording medium 10 to store, as data for setting recording conditions, all of the preferred range of a linear recording velocity to be set when data are recorded in the optical recording medium 10, the pulse train patterns shown in FIGS. 3 to 6 and a preferred range of the ratio Pe/Pw of the erasing power Pe to the recording power Pw of a laser beam L to be used for modulating the power of the laser beam L when data are recorded in the optical recording medium 10 but the optical recording medium 10 may store only a part or parts thereof. Further, it is possible to write ID data for identifying the optical recording medium 10 in the optical recording medium, store all, or a part or parts of the data for setting recording conditions in the memory of the data recording apparatus and cause the data recording apparatus to read the data for setting recording conditions from the memory in accordance with the ID data and set the recording conditions of data.

According to the present invention, it is possible to provide a data rewritable type optical recording medium whose characteristics of recording data therein at a high linear velocity can be improved and whose data reproduction durability and storage reliability can be simultaneously improved.

Further, according to the present invention, it is possible to provide a data recording apparatus which can record data in an optical recording medium at a high linear velocity and directly overwrite data recorded in an optical recording medium at a high linear velocity.

1. An optical recording medium comprising a recording layer in which a record mark can be formed by projecting a laser beam thereonto, a first dielectric layer disposed on the side of the recording layer on which a light incidence plane through which the laser beam enters is present, a second dielectric layer disposed on the side of the recording layer opposite from that on which the light incidence plane is present, a heat radiation layer disposed on the side of the first dielectric layer on which the light incidence plane is present and a reflective layer disposed on the side of the second dielectric layer opposite from that on which the light incidence plane is present, the recording layer containing a phase change material represented by an atomic composition formula: SbₐTe_{b}Ge_{c}Tb_{d}, where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9, in an amount equal to or more than 95 atomic %.

2. An optical recording medium in accordance with claim 1, wherein the heat radiation layer contains aluminum nitride as a primary component.

3. An optical recording medium in accordance with claim 2, wherein the heat radiation layer is formed of a material containing 90 atomic % or more aluminum nitride.

4. An optical recording medium in accordance with claim 1, wherein the reflective layer contains Ag or alloy containing 90 atomic % or more of Ag.

5. An optical recording medium in accordance with claim 2, wherein the reflective layer contains Ag or alloy containing 90 atomic % or more of Ag.

6. An optical recording medium in accordance with claim 1, wherein the first dielectric layer is formed so as to have a thickness of 10 nm to 40 nm.

7. An optical recording medium in accordance with claim 12, wherein the second dielectric layer is formed so as to have a thickness of 3 nm to 14 nm.

8. An optical recording medium in accordance with claim 1, wherein there is written thereinto as data for setting recording conditions a pulse train pattern for modulating laser beam power between three levels including a recording power, an erasing power and a bottom power, wherein the number of pulses having a level equal to a recording power of the laser beam at the time of forming a record mark having a length of nT in the recording layer, where n is an integer equal to or larger than 2 and T is a length corresponding to one cycle of a reference clock, is determined to be n/2 when n is an even number and to be (n-1)/2 when n is an odd number.

9. An optical recording medium in accordance with claim 2, wherein there is written thereinto as data for setting recording conditions a pulse train pattern for modulating laser beam power between three levels including a recording power, an erasing power and a bottom power, wherein the number of pulses having a level equal to a recording power of the laser beam at the time of forming a record mark having a length of nT in the recording layer, where n is an integer equal to or larger than 2 and T is a length corresponding to one cycle of a reference clock, is determined to be n/2 when n is an even number and to be (n-1)/2 when n is an odd number.

10. An optical recording medium in accordance with claim 4, wherein there is written thereinto as data for setting recording conditions a pulse train pattern for modulating laser beam power between three levels including a recording power, an erasing power and a bottom power, wherein the number of pulses having a level equal to a recording power of the laser beam at the time of forming a record mark having a length of nT in the recording layer, where n is an integer equal to or larger than 2 and T is a length corresponding to one cycle of a reference clock, is determined to be n/2 when n is an even number and to be (n-1)/2 when n is an odd number.

11. An optical recording medium in accordance with claim 1, wherein a linear recording velocity equal to or higher than 14 m/sec and lower than 21 m/sec is written therein as data for setting recording conditions indicating a preferable linear recording velocity of data.

12. An optical recording medium in accordance with claim 2, wherein a linear recording velocity equal to or higher than 14 m/sec and lower than 21 m/sec is written therein as data for setting recording conditions indicating a preferable linear recording velocity of data.

13. An optical recording medium in accordance with claim 4, wherein a linear recording velocity equal to or higher than 14 m/sec and lower than 21 m/sec is written therein as data for setting recording conditions indicating a preferable linear recording velocity of data.

14. An optical recording medium in accordance with claim 11, wherein data for setting recording conditions indicating that a ratio Pe/Pw of an erasing power of a laser beam Pe to a recording power Pw thereof should be determined to be equal to or larger than 0.26 and equal to or smaller than 0.7 are further written in the optical recording medium.

15. An optical recording medium in accordance with claim 12, wherein data for setting recording conditions indicating that a ratio Pe/Pw of an erasing power of a laser beam Pe to a recording power Pw thereof should be determined to be equal to or larger than 0.26 and equal to or smaller than 0.7 are further written in the optical recording medium.

16. An optical recording medium in accordance with claim 13, wherein data for setting recording conditions indicating that a ratio Pe/Pw of an erasing power of a laser beam Pe to a recording power Pw thereof should be determined to be equal to or larger than 0.26 and equal to or smaller than 0.7 are further written in the optical recording medium.

17. An optical recording medium in accordance with claim 1, wherein ID data for identifying the optical recording medium are written therein.

18. An optical recording medium in accordance with claim 2, wherein ID data for identifying the optical recording medium are written therein.

19. An optical recording medium in accordance with claim 4, wherein ID data for identifying the optical recording medium are written therein.

20. A data recording apparatus comprising ID data reading means for reading ID data written in an optical recording medium for identifying the optical recording medium, a memory for storing data for setting recording conditions for each of ID data written in the optical recording media, and control means for setting recording conditions of data that, when the ID data indicates that the optical recording medium comprises a recording layer in which a record mark can be formed by projecting a laser beam thereonto, a first dielectric layer disposed on the side of the recording layer on which a light incidence plane through which the laser beam enters is present, a second dielectric layer disposed on the side of the recording layer opposite from that on which the light incidence plane is present, a heat radiation layer disposed on the side of the first dielectric layer on which the light incidence plane is present and a reflective layer disposed on the side of the second dielectric layer opposite from that on which the light incidence plane is present, and that the recording layer contains a phase change material represented by an atomic composition formula: SbₐTe_{b}Ge_{c}Tb_{d}, where a is equal to or larger than 63 and equal to or smaller than 78, c is equal to or larger than 2 and equal to or smaller than 10, d is equal to or larger than 3 and equal to or smaller than 15, (a+d) is equal to or larger than 75 and equal to or smaller than 82 and a/b is equal to or larger than 3.3 and equal to or smaller than 4.9, in an amount equal to or more than 95 atomic %, selects data for setting recording conditions stored in the memory in accordance with the values of a, c, d, (a+d) and a/b.
